(19) United States
(12) Patent Application Publication
(10) Pub. No.: US 2025/0261231 A1
(43) Pub. Date: Aug. 14, 2025

(54) NETWORK ALLOCATION VECTOR IN WIRELESS NETWORKS

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US)

(21) Appl. No.: 19/046,381

(22) Filed: Feb. 5, 2025

Related U.S. Application Data
(60) Provisional application No. 63/553,502, filed on Feb. 14, 2024.

(51) Int. Cl. H04W 74/0808; H04W 72/0446

(52) U.S. Cl. CPC H04W 74/0808; H04W 72/0446

(57) ABSTRACT

A first station (STA) transmits a TXOP allocation announcement frame to a second STA in order to announce an upcoming transmission opportunity (TXOP) allocation schedule. The TXOP allocation announcement frame includes intended recipients for upcoming TXOP allocation and duration information for TXOP. The duration information is used for NAV setting in receiving STAs.

### CROSS-REFERENCE TO RELATED APPLICATION(S)

This application claims the benefit of priority from U.S. Provisional Application No. 63/553,502, entitled “NAV SETTING ENHANCEMENTS FOR MULTI-AP TXOP SHARING,” filed Feb. 14, 2024, which is incorporated herein by reference in its entirety.

### TECHNICAL FIELD

This disclosure relates generally to a wireless communication system, and more particularly to, for example, but not limited to, a network allocation vector (NAV) in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first station (STA) in a wireless network. The first STA comprises a memory and a processor coupled to the memory. The processor is configured to cause: obtaining a transmission opportunity (TXOP) for a first duration on a wireless channel; transmitting a first frame that announces an upcoming TXOP allocation schedule, the first frame including i) one or more recipient STAs for upcoming TXOP allocation and ii) duration information for setting a network allocation vector (NAV) by one or more STAs receiving the first frame, the duration information being associated with the first duration; receiving, from one or more second STAs, one or more second frames that acknowledge the first frame, wherein each second STA is a recipient STA; and transmitting, to the or more second STAs, a third frame allocating a portion of obtained TXOP based on the upcoming TXOP allocation schedule.

In some embodiments, each second frame includes duration information for setting a NAV by one or more receiving STAs, the duration information of each second frame is associated with the first duration.

In some embodiments, the first frame is a multi-user (MU) request-to-send (RTS) trigger frame, and each second frame is a CTS frame, the MU-RTS trigger frame soliciting simultaneous CTS frames from two or more second STAs.

In some embodiments, the third frame is a MU-RTS TXOP sharing trigger frame that indicates a time allocated to the one or more second STAs within the obtained TXOP.

In some embodiments, the first STA is either an AP STA or a non-AP STA, and each of the one or more second STAs is either an AP STA or a non-AP STA.

In some embodiments, the first STA is a first AP STA, and a second STA is a second AP STA; and the first AP STA and the second AP STA participates in a time division multiple access (TDMA)-based multi-AP coordination.

In some embodiments, the processor is further configured to cause receiving, from the second AP STA, a second frame that acknowledges the first frame, the second frame including duration information for setting a NAV by one or more non-AP STA in a BSS in the second AP STA.

In some embodiments, the duration information is associated with the first duration.

An aspect of the disclosure provides a first station (STA) in a wireless network. The first STA comprises a memory and a processor coupled to the memory. The processor is configured to cause: receiving, from a second STA, a first frame that announces an upcoming transmission opportunity (TXOP) allocation schedule, the first frame including i) one or more recipient STAs for upcoming TXOP allocation and ii) duration information for setting a network allocation vector (NAV) by one or more STAs receiving the first frame, the duration information being associated with TXOP obtained by the second STA; transmitting, to the second STA, a second frame that acknowledges the first frame based on a determination that the first STA is a recipient STA for upcoming TXOP allocation; receiving, from the second STA, a third frame allocating a portion of the TXOP based on the upcoming TXOP allocation schedule; and performing a communication with another STA based on the allocated portion of the TXOP.

In some embodiments, the second frame includes duration information for setting a NAV by one or more receiving STAs, the duration information is associated with the TXOP.

In some embodiments, the first frame is a multi-user (MU) request-to-send (RTS) trigger frame, and the second frame is a CTS frame.

In some embodiments, the third frame is a MU-RTS TXOP sharing trigger frame that indicates a time allocated to the first STA within the TXOP.

In some embodiments, the first STA is either an AP STA or a non-AP STA, and the second STA is either an AP STA or a non-AP STA.

In some embodiments, the first STA is a first AP STA, and a second STA is a second AP STA; and the first AP STA and the second AP STA participates in a time division multiple access (TDMA)-based multi-AP coordination.

In some embodiments, the processor is configured to cause transmitting, to the second AP STA, a second frame that acknowledges the first frame, the second frame including duration information for setting a NAV by one or more non-AP STA in a BSS in the first AP STA, the duration information being associated with the TXOP.

An aspect of the disclosure provides a method performed by a first station (STA) in a wireless network. The method comprises: obtaining a transmission opportunity (TXOP) for a first duration on a wireless channel; transmitting a first frame that announces an upcoming TXOP allocation schedule, the first frame including i) one or more recipient STAs for upcoming TXOP allocation and ii) duration information for setting a network allocation vector (NAV) by one or more STAs receiving the first frame, the duration information being associated with the first duration; receiving, from one or more second STAs, one or more second frames that acknowledge the first frame, wherein each second STA is a recipient STA; and transmitting, to the or more second STAs, a third frame allocating a portion of obtained TXOP based on the upcoming TXOP allocation schedule.

In some embodiments, each second frame includes duration information for setting a NAV by one or more receiving STAs, the duration information of each second frame is associated with the first duration.

In some embodiments, the first frame is a multi-user (MU) request-to-send (RTS) trigger frame, and each second frame is a CTS frame, the MU-RTS trigger frame soliciting simultaneous CTS frames from two or more second STAs.

In some embodiments, the third frame is a MU-RTS TXOP sharing trigger frame that indicates a time allocated to the one or more second STAs within the obtained TXOP.

In some embodiments, the first STA is a first AP STA, and a second STA is a second AP STA; the first AP STA and the second AP STA participates in a time division multiple access (TDMA)-based multi-AP coordination; and the method further comprising receiving, from the second AP STA, a second frame that acknowledges the first frame, the second frame including duration information for setting a NAV by one or more non-AP STA in a BSS in the second AP STA, wherein the duration information is associated with the first duration.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example MAP coordination in accordance with an embodiment.

FIG. 5 shows an example Type-1 architecture for C-TDMA negotiation in accordance with an embodiment.

FIG. 6 shows an example Type-2 architecture for C-TDMA negotiation in accordance with an embodiment.

FIG. 7 shows an example scenario of TXOP allocation announcement frame and acknowledgment response in accordance with an embodiment.

FIG. 8 shows another example scenario of TXOP allocation announcement frame and acknowledgment response in accordance with an embodiment.

FIG. 9 shows another example scenario of TXOP allocation announcement frame and acknowledgment response in accordance with an embodiment.

FIG. 10 shows another example scenario of TXOP allocation announcement frame and acknowledgment response in accordance with an embodiment.

FIG. 11 shows another example scenario of TXOP allocation announcement frame and acknowledgment response in accordance with an embodiment.

FIG. 12 shows an example process for a TXOP sharing in accordance with an embodiment.

FIG. 13 shows an example process for a TXOP sharing in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

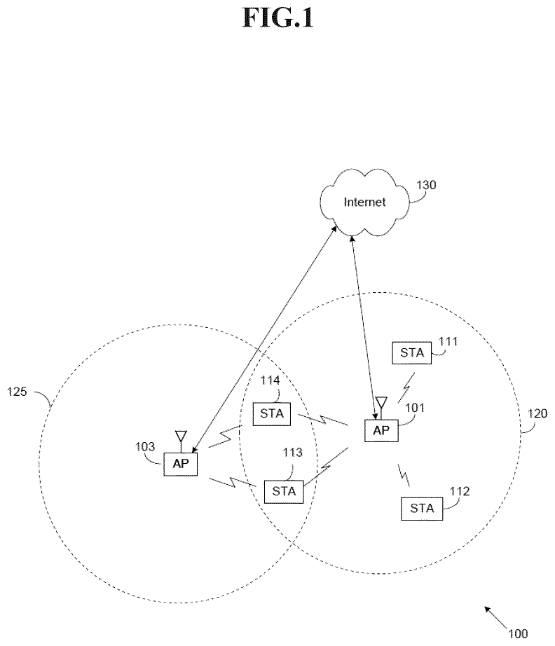

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

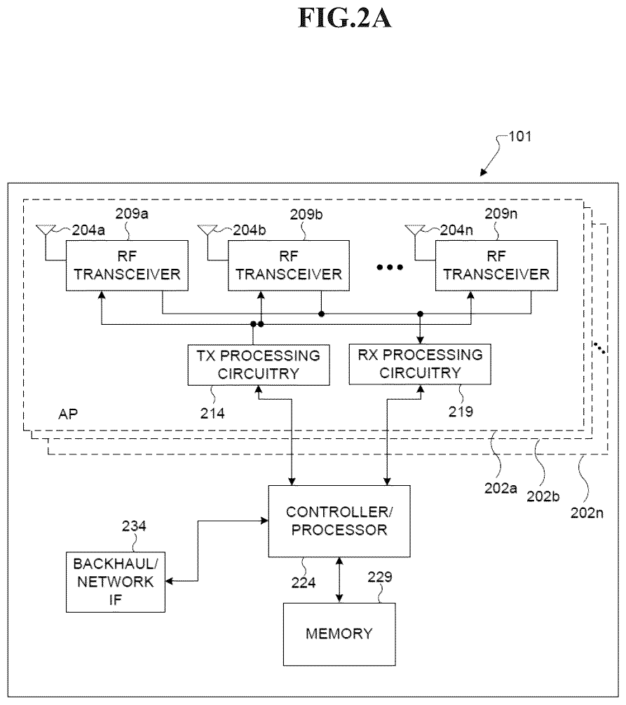

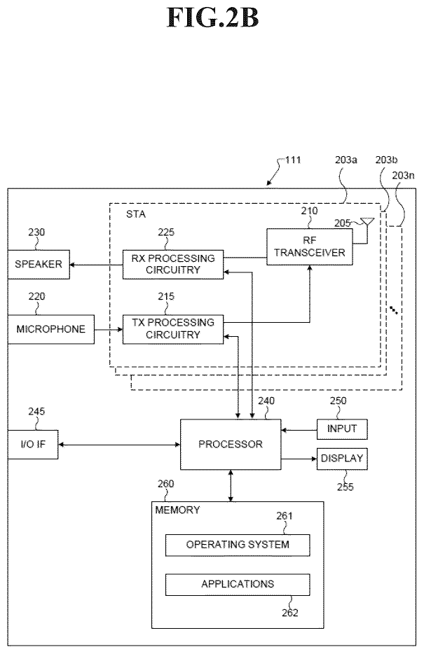

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

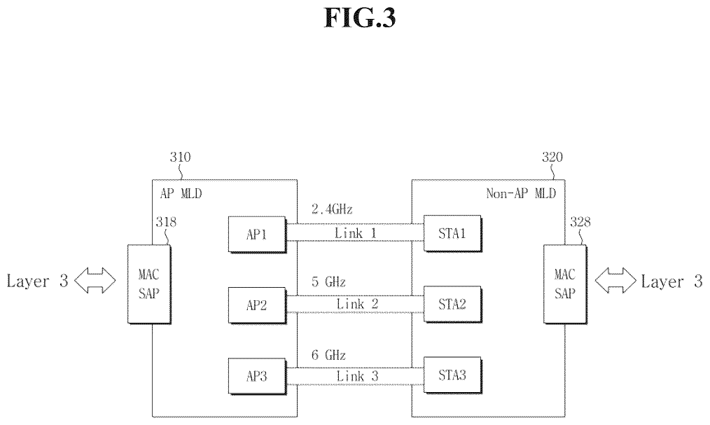

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D4.0, “Wireless LAN Medium Access Control (MAC) and Physical Layer (PHY) Specifications.”

A multi-AP (MAP) coordination is considered as one of the key features for next generation WLAN systems. In the MAP coordination, multiple neighboring APs coordinate with each other for improved network performance.

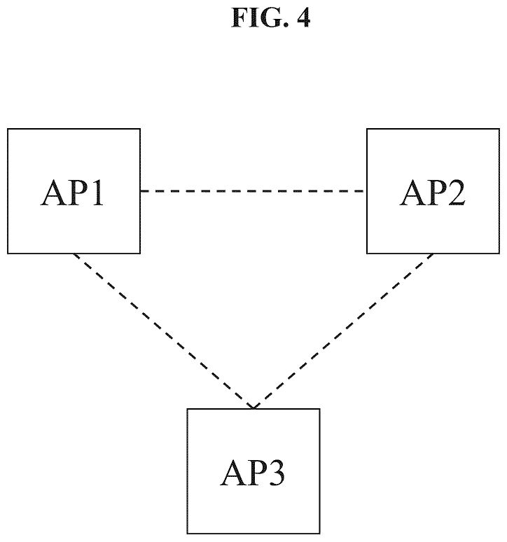

FIG. 4 shows an example MAP coordination in accordance with an embodiment. The MAP coordination depicted in FIG. 4 is for explanatory and illustration purposes. FIG. 4 does not limit the scope of this disclosure to any particular implementation.

As shown in FIG. 4, the MAP coordination may be performed in a group of APs, for example, including AP1, AP2, and AP3. AP1, AP2 and AP3 may coordinate with each other in order to reduce latency resulting from natural overall throughput degradation and/or overlapping basic service set (OBSS) interference. As a result, AP1, AP2 and AP3 improve network performance through MAP coordination.

Interference from one basic service set (BSS) may cause performance issues for STAs and APs in nearby BSSs. This naturally results in overall throughput degradation in the network. The overlapping BSS (OBSS) interference may increase the overall latency since it takes more time to access the channel due to the interference occupying the channel. A delay in channel access may seriously interfere an STA's latency-sensitive applications when the STA is in a nearby BSS and has latency-sensitive traffic. To address these problems, Time Division Multiple Access (TDMA)-based MAP coordination can be an important feature for next generation WLAN networks.

In some embodiments, a first AP may coordinate with a second AP in the vicinity on the basis of coordinated TDMA (C-TDMA) scheme. The coordination mechanism can take different formats based on the architecture of C-TDMA mechanism.

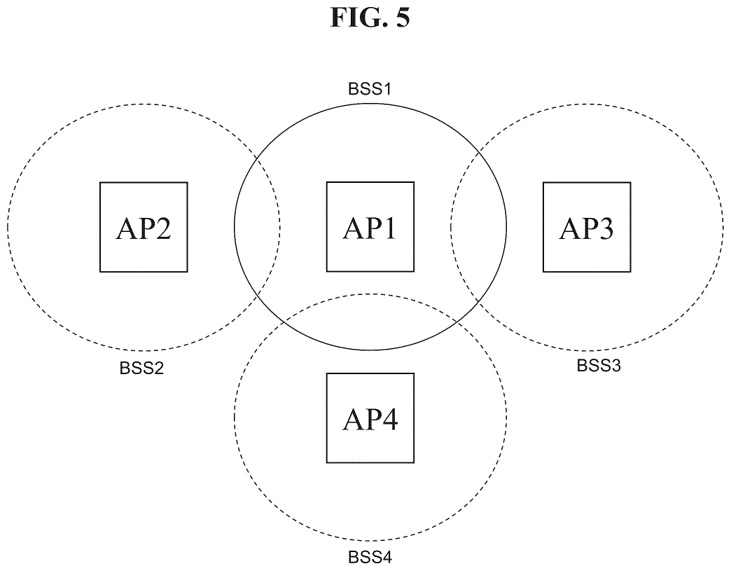

In some embodiments, in a Type-I architecture of C-TDMA negotiation, the APs participating in a TDMA-based MAP coordination may directly exchange frames within themselves to negotiate on the TDMA-based MAP coordination. An example Type-I architecture for C-TDMA negotiation is shown in FIG. 5.

FIG. 5 shows an example Type-1 architecture for C-TDMA negotiation in accordance with an embodiment. The architecture depicted in FIG. 5 is for explanatory and illustration purposes. FIG. 5 does not limit the scope of this disclosure to any particular implementation.

Referring to FIGS. 5, AP1, AP2, AP3 and AP4 form BSS1, BSS2, BSS3 and BSS4, respectively. BSS1 partially overlaps with BSS2, BSS3 and BSS4. A group of APs participating in the TDMA-based MAP coordination, including AP1, AP2, AP3 and AP4, directly exchange frames with each other to negotiate on the C-TDMA.

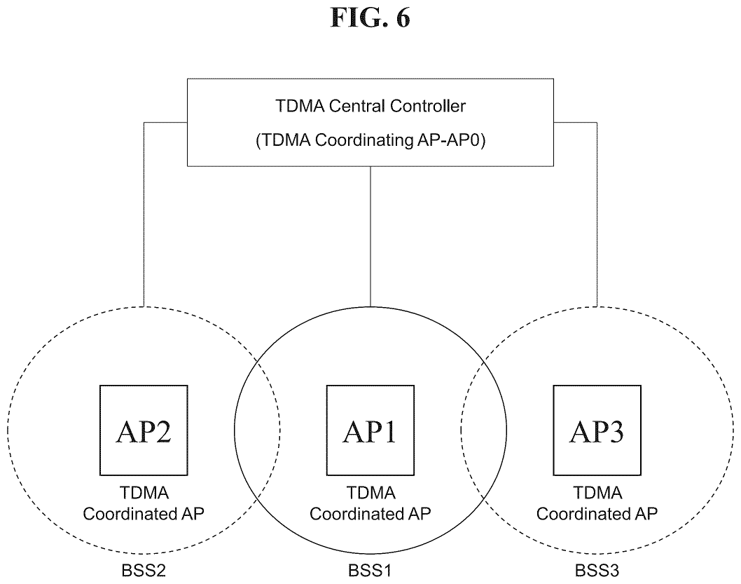

In some embodiments, in a Type-2 architecture of C-TDMA negotiation, C-TDMA negotiations between participating APs may be controlled by a C-TDMA central controller. The C-TDMA central controller may perform C-TDMA MAP negotiations. An example Type-II architecture for C-TDMA negotiation is illustrated in FIG. 6.

FIG. 6 shows an example Type-2 architecture for C-TDMA negotiation in accordance with an embodiment. The architecture depicted in FIG. 6 is for explanatory and illustration purposes. FIG. 6 does not limit the scope of this disclosure to any particular implementation.

Referring to FIGS. 6, AP1, AP2, and AP3 form BSS1, BSS2, and BSS3, respectively. BSS1 partially overlaps with BSS2 and BSS3. A group of APs participating in the TDMA-based MAP coordination, including AP1, AP2, and AP3, are connected to a C-TDMA Central Controller AP 0, which coordinates the C-TDMA MAP negotiation among the participating APs.

In WLAN, a network allocation vector (NAV) is one of key features that helps prevent collisions by indicating a time duration for which the wireless medium (or channel) will remain busy. It functions as a virtual carrier-sensing mechanism, allowing STAs to avoid collisions by deferring transmission while the wireless medium is occupied. In the next generation WLAN system, a MAP transmission opportunity (TXOP) sharing can be considered as an important feature to implement the C-TDMA scheme or the TDMA-based MAP coordination. However, the NAV setting procedure for MAP TXOP sharing has not yet been defined.

The disclosure presents various embodiments, including protocols and mechanisms, for setting or updating the NAV by TXOP sharing STAs and TXOP shared STAs. Additionally, the disclosure presents various embodiments for setting NAVs using a frame that announces the schedule for the TXOP sharing.

In some embodiments, an AP may transmit a TXOP allocation announcement frame to one or more other STAs (i.e., AP STAs and/or non-AP STAs) to announce a subsequent (or upcoming) TXOP allocation schedule in a broadcast or multicast manner. The TXOP allocation announcement frame may include duration information for NAV setting and protection of the TXOP to reserve the medium for the entire TXOP period or the entire duration of TXOP allocation schedule. In an implementation, the duration information may be associated with an estimated time until the end of the entire TXOP period. In an implementation, the duration information may be included in a duration field of the TXOP allocation announcement frame. In an implementation, the duration information may be included in a TXOP field of the TXOP allocation announcement frame. Upon receiving the TXOP allocation announcement frame, other STAs may update their NAV timer based on the duration information included in the TXOP allocation announcement frame. In an embodiment, when a STA associated with the AP receives the TXOP allocation announcement frame, the STA may send an acknowledgement frame to the AP. If the TXOP allocation announcement frame is an MU-RTS trigger frame, the STA may send a clear-to-send (CTS) frame in response. The CTS frame may include a duration field indicating an estimated remaining time until the end of the entire TXOP period. This duration may be an adjustment to the duration indicated by the MU-RTS trigger frame by subtraction of time required to transmit the CTS frame in response to the MU-RTS frame. Upon receiving the CTS frame, other STAs may update or confirm their NAV timer based on the duration included in the CTS frame.

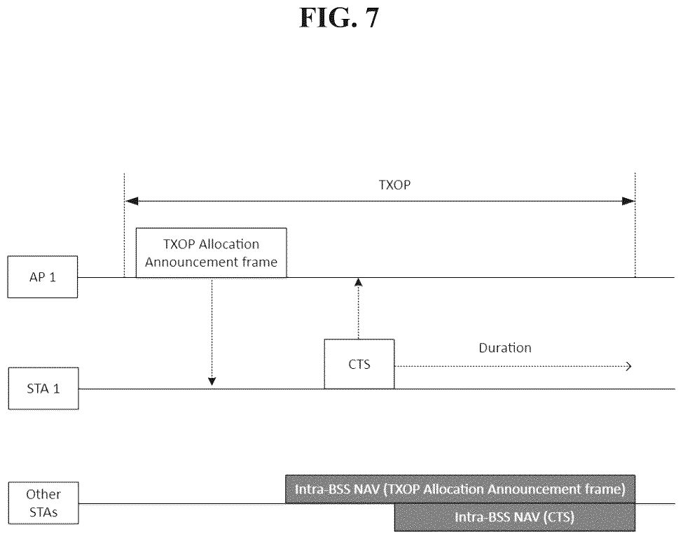

FIG. 7 shows an example scenario of TXOP allocation announcement frame and acknowledgment response in accordance with an embodiment.

Referring to FIG. 7, AP 1 initially obtains a TXOP on the medium. Then, AP 1 transmits a TXOP allocation announcement frame to STA 1 to announce an upcoming TXOP allocation schedule. The TXOP allocation announcement frame may be a broadcast frame or a multicast frame. In an implementation, the TXOP allocation announce frame may be a MU-RTS trigger frame. In another implementation, the TXOP allocation announcement frame may be a buffer status report poll (BSRP) trigger frame. In another implementation, the TXOP allocation announcement frame may be a multi-STA Block Ack frame. The TXOP allocation announcement frame includes duration information for NAV setting and protection of the obtained TXOP. In an implementation, the duration information may indicate a time to the end of the obtained TXOP. Upon receiving the TXOP allocation announcement frame, other STAs may set or update their NAV timer based on the duration information included in the TXOP allocation announcement frame. In response, STA 1 sends a CTS frame including a duration field that indicates a time to the end of the TXOP period obtained by AP 1. Upon receiving the CTS frame, other STAs may confirm or update their NAV timer based on the duration indicated by the CTS frame. In this example, AP 1, STA 1, and other STAs belong to the same BSS, and the NAVs set or updated may be an intra-BSS NAV. In an embodiment, the intra-BSS NAV refers to a NAV that is updated by an intra-BSS PPDU.

In some embodiments, when an AP transmits a TXOP allocation announcement frame to an associated STA, the STA may send an acknowledgment frame to the AP in response if the STA is indicated in the TXOP allocation announcement frame as a recipient of the upcoming TXOP from the AP. In an implementation, the TXOP allocation announcement frame is an MU-RTS trigger frame, the acknowledgment frame is a CTS frame. The CT frame includes a duration field that indicates a time until the end of the entire TXOP period indicated by the AP. Upon receiving the CTS frame, other STAs may set or update their NAV timer based on the duration indicated by the CTS frame. In order to identify the STA as a recipient in the TXOP allocation announcement frame, the AP may use an identifier for the STA, such as association ID (AID), MLD MAC address, or STA MAC address.

In some embodiments, an AP transmits a TXOP allocation announcement frame to an associated STA to announce the upcoming TXOP allocation schedule. The TXOP allocation announcement frame indicates the entire duration of the TXOP obtained on the medium. The STA may not send an acknowledgement frame of CTS frame to the AP if the STA is not indicated as a recipient of the upcoming TXOP in the TXOP allocation announcement frame. Then, the STA set or update its NAV timer based on the TXOP duration indicated in the TXOP allocation announcement frame.

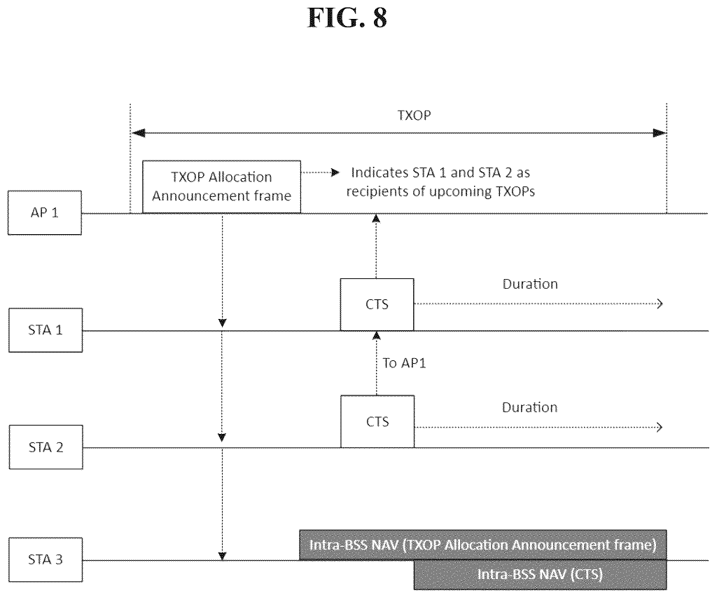

FIG. 8 shows another example scenario of TXOP allocation announcement frame and acknowledgment response in accordance with an embodiment.

Referring to FIG. 8, AP 1 initially obtains a TXOP on the medium. Then, AP 1 transmits a TXOP allocation announcement frame to announce an upcoming TXOP allocation schedule. The TXOP allocation announcement frame indicates STA 1 and STA 2 as intended recipients of the upcoming TXOPs. Additionally, the TXOP allocation announcement frame indicates duration information indicating the entire duration of the obtained TXOP for NAV setting and protection of the TXOP. For example, the time until the end of the entire TXOP can be indicated in the TXOP allocation announcement frame.

In response, STA 1 sends a CTS frame to AP 1 as an acknowledgement since it is designated as a recipient STA for an upcoming TXOP. The CTS frame includes a duration field indicating the TXOP period-for example, but not limiting to, a time remaining until the end of the TXOP obtained by AP 1. STA 2 also sends a CTS frame to AP 1 as an acknowledgement. Similarly, the CTS frame includes a duration field indicating the TXOP period-for example, but not limited to, a time remaining until the end of the TXOP obtained by AP 1. In an embodiment, the TXOP allocation announcement frame is a MU-RTS trigger frame, a BSRP trigger frame, or a multi-STA Block Ack frame, and STA 1 and STA 1 may operate on different subchannel-for example, different 20 MHz subchannels. STA 1 and STA 2 simultaneously transmit their CTS frames to AP 1. However, STA 3 does not send a CTS frame, as it is not designated as a recipient STA for any upcoming TXOPs. Instead, upon receiving the TXOP allocation announcement frame, STA 3 updates its NAV based on the duration information indicated in the TXOP allocation announcement frame. Additionally, upon listening to CTS frame from STA 1 or STA 2, STA 3 updates or confirm its NAV timer based on a duration indicated by the CTS frame. In this example, STA 1, STA 2, and STA 3 may be all associated with AP 1, and the NAV may be an intra-BSS NAV.

In some embodiments, a first AP transmits a TXOP allocation announcement frame to a second AP to announce an upcoming TXOP allocation schedule. The TXOP allocation announce frame indicates the duration of the obtained TXOP. In response, the second AP may send an acknowledgement frame to the first AP. In an implementation, the TXOP allocation announcement frame may be an MU-RTS trigger frame, and the acknowledgement frame may be a CTS frame. The CTS frame may include a duration field indicating the TXOP period-for example, an estimated time until the end of the entire TXOP period. Upon listening to the CTS frame, other STAs within the AP 2′s BSS update their NAV timer based on the duration included in the CTS frame. In this example, the NAV may be an intra-BSS NAV.

In some embodiments, a first AP transmits a TXOP allocation announcement frame to a second AP to announce an upcoming TXOP allocation schedule. The TXOP allocation announcement frame indicates the entire duration of the TXOP obtained on the medium. In response, the second AP may send an acknowledgment frame to the first AP if the second STA is indicated in the TXOP allocation announcement frame as an intended recipient of the upcoming TXOP from the first AP. In an implementation, the TXOP allocation announcement frame may be an MU-RTS trigger frame, and the acknowledgment frame may be a CTS frame. The CTS frame includes a duration field that indicates an estimated time until the end of the entire TXOP period indicated by the first AP. Upon listening to the CTS frame, other STAs in the second AP's BSS may set or update their NAV timer based on the duration indicated by the CTS frame. The NAV may be an intra-BSS NAV.

In some embodiments, a first AP transmits a TXOP allocation announcement frame to a second AP to announce an upcoming TXOP allocation schedule. The TXOP allocation announcement frame indicates duration information for the entire duration of the TXOP obtained on the medium. The second AP may not send an acknowledgement frame to the first AP if the second AP is not designated as an intended recipient of the upcoming TXOP by the first AP. Then, the second STA set or updates its NAV timer based on the duration information (e.g., TXOP period) indicated in the TXOP allocation announcement frame. In an embodiment, the NAV is a basic NAV. The basic NAV may refer to a NAV that is updated by an inter-BSS PPDU or a PPDU that cannot be classified as intra-BSS or inter-BSS. In another embodiment, the NAV is an intra-BSS NAV.

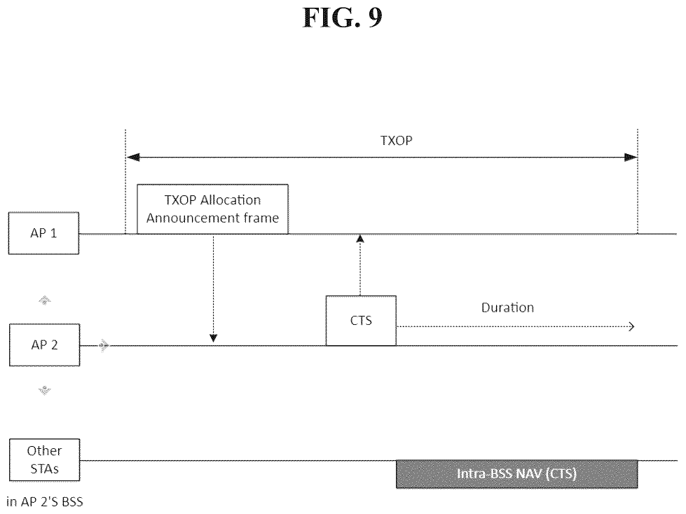

FIG. 9 shows another example scenario of TXOP allocation announcement frame and acknowledgment response in accordance with an embodiment.

Referring to FIG. 9, AP 1 initially obtains a TXOP on the medium. Then, AP 1 transmits a TXOP allocation announcement frame to announce an upcoming TXOP allocation schedule. In an implementation, the TXOP allocation announce frame may be a MU-RTS trigger frame. The TXOP allocation announcement frame includes duration information for the obtained TXOP. In response, AP 2 sends a CTS frame including duration information for the entire duration of the TXOP period obtained by AP 1. This duration information is used for NAV setting in the BSS of the AP 2. In an embodiments, AP 1 and AP 2 are participating in the C-TDMA. Upon receiving the CTS frame, other STAs in the BSS of the AP 2 may update their NAV timer based on the duration indicated by the CTS frame. In this example, AP 2 and other STAs belong to the same BSS, and the NAVs may be an intra-BSS NAV.

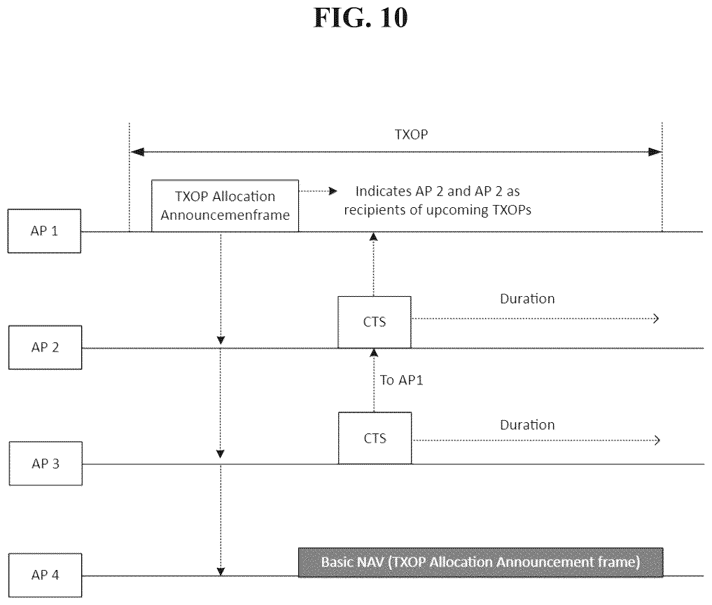

FIG. 10 shows another example scenario of TXOP allocation announcement frame and acknowledgment response in accordance with an embodiment.

Referring to FIG. 10, AP 1 initially obtains a TXOP on the medium. Then, AP 1 transmits a TXOP allocation announcement frame to AP 1, AP 2, and AP 3 in order to announce an upcoming TXOP allocation schedule. The TXOP allocation announcement frame indicates AP 2 and AP 3 as intended recipients of the upcoming TXOPs. Additionally, the TXOP allocation announcement frame indicates the entire duration of the obtained TXOP. In an embodiment, an estimated time until the end of the entire TXOP can be indicated in the TXOP allocation announcement frame. AP 2, AP 3, and AP 4 may participate with AP 1 in the TDMA-based multi-AP coordination.

In response, AP 2 sends a CTS frame to AP 1 as an acknowledgement since it is designated as a recipient STA for an upcoming TXOP. The CTS frame includes a duration field indicating a time remaining until the end of the TXOP obtained by AP 1. Other STAs in the AP 2's BSS that listen to the CTS frame update their NAV timer based on the duration of the CTS frame. The NAV may be an intra-BSS NAV.

AP 3 also sends a CTS frame to AP 1 as an acknowledgement since it is designated as a recipient STA for an upcoming TXOP. Similarly, the CTS frame includes a duration field indicating a time remaining until the end of the TXOP obtained by AP 1. Other STAs in the AP 3's BSS that listen to the CTS frame update their NAV timer based on the duration of the CTS frame. The NAV may be an intra-BSS NAV. AP 2 and AP 3 may simultaneously transmit their CTS frames to AP 1.

However, AP 4 does not send a CTS frame, as it is not designated as a recipient STA for any upcoming TXOP in the TXOP allocation announcement frame. Instead, upon receiving the TXOP allocation announcement frame, AP 4 updates its NAV based on the duration information (e.g., TXOP period) indicated in the TXOP allocation announcement frame. The NAV may be a basic NAV. In another embodiment, the NAV may be an intra-BSS NAV, a basic NAV, or an inter-BSS NAV.

In some embodiments, a first AP transmits a TXOP allocation announcement frame to a first STA that is not associated with the first AP. The first STA may set or update its NAV based on a TXOP duration indicated in the TXOP allocation announcement frame. In an embodiment, the NAV set or updated by the first STA may be an intra-BSS NAV, an inter-BSS NAV, or a basic NAV.

In some embodiments, a first AP transmits a TXOP allocation announcement frame to a second AP. If the second AP is indicated as an intended recipient of an upcoming TXOP schedule in the TXOP allocation announcement frame, a first STA associated with the second AP may set its NAV based on the TXOP duration indicated in the TXOP allocation announcement frame. However, if the second AP is not indicated as an intended recipient of any upcoming TXOPs, the first STA may not set the NAV.

In some embodiments, a first AP transmits a TXOP allocation announcement frame to a second AP. If the second AP is indicated as an intended recipient of an upcoming TXOP schedule in the TXOP allocation announcement frame, a first STA that is associated with the second AP may set it NAV based on the TXOP duration indicated in the TXOP allocation announcement frame. The NAV may be an intra-BSS NAV. On the other hand, if the second AP is not indicated as an intended recipient of any upcoming TXO schedules, a first STA that is associated with the second AP may set it NAV based on the TXOP duration indicated in the TXOP allocation announcement frame. The NAV may be a basic NAV.

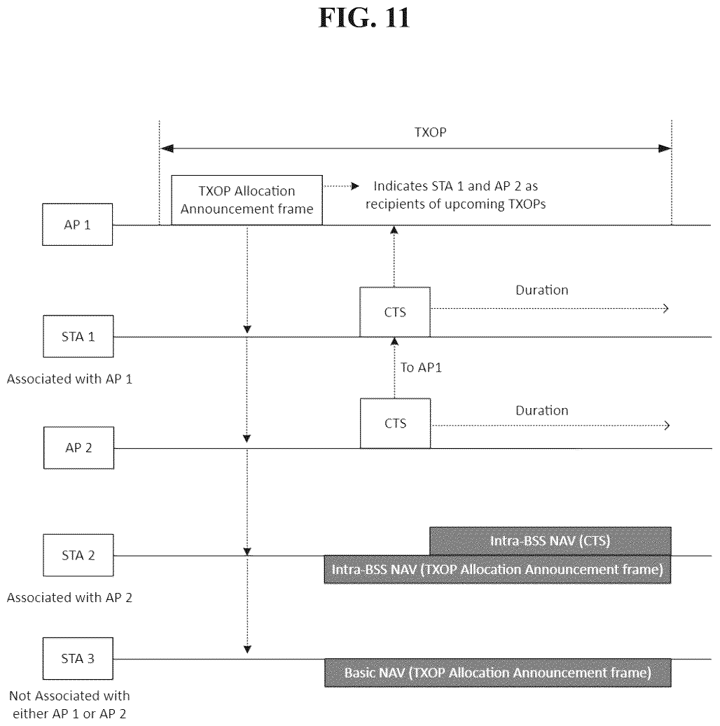

FIG. 11 shows another example scenario of TXOP allocation announcement frame and acknowledgment response in accordance with an embodiment.

Referring to FIG. 11, AP 1 initially obtains a TXOP on the medium. Then, AP 1 transmits a TXOP allocation announcement frame in order to announce an upcoming TXOP allocation schedule. The TXOP allocation announcement frame indicates STA 1 and AP 2 as an intended recipient of upcoming TXOPs. Additionally, the TXOP allocation announcement frame indicates the entire duration of the obtained TXOP. In an embodiment, an estimated time until the end of the entire TXOP duration can be indicated in the TXOP allocation announcement frame. In this example, the TXOP allocation announcement frame may be received by STA 1, AP 2, STA 2, and STA 3. STA 1 is associated with AP 1, AP 2 is associated with AP 1 or is participating in a multi-AP coordination (C-TDMA) with AP 1, STA 2 is associated with AP 2, and STA 3 is not associated with either AP 1 or AP 2.

In response, STA 1 determines that STA 1 is an intended recipient of an upcoming TXOP from the TXOP allocation announcement frame. Then, STA 1 sends a CTS frame as an acknowledgment. The CTS frame may include duration information for the TXOP indicated by the TXOP allocation announcement frame. Other STAs (not shown in FIG. 11) in AP 1′ BSS that listen to the CTS frame may update their NAV based on the duration field of the CTS frame. The NAV may be an intra-BSS NAV.

AP 2 determines that AP 2 is an intended recipient of an upcoming TXOP from the TXOP allocation announcement frame. Then, AP 2 sends a CTS frame as an acknowledgment. The CTS frame may include duration information for the TXOP indicated by the TXOP allocation announcement frame. Other STAs in AP 2′ BSS, including STA 2, that listen to the CTS frame may update their NAV based on the duration field of the CTS frame.

STA 2 receives the TXOP allocation announcement frame and determines that STA 2 is not associated with AP 1. Then, STA 2 updates its NAV based on the TXOP duration indicated in the TXOP allocation announcement frame. The NAV can be an intra-BSS NAV, or a basic NAV. Additionally, upon listening to the CTS frame transmitted from AP 2 that is associated with the STA 2, STA 2 set its NAV based on the duration field of the CTS frame. This NAV may be an intra-BSS NAV.

STA 3 receives the TXOP allocation announcement frame and determines that STA 3 is not associated with either AP 1 or AP 2. Then, STA 3 updates its NAV based on the TXOP duration indicated in the TXOP allocation announcement frame. The NAV can be a basic NAV or an intra-BSS NAV.

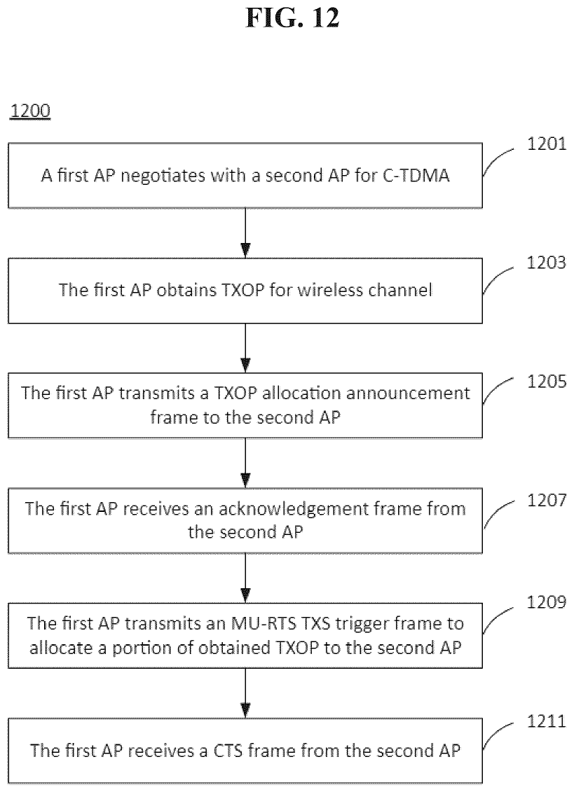

FIG. 12 shows an example process 1200 for a TXOP sharing in accordance with an embodiment. For explanatory and illustration purposes, the process 1200 may be performed by a TXOP sharing AP. Although one or more operations are described or shown in a particular sequential order, in other embodiments the operations may be rearranged in a different order, which may include performance of multiple operations in at least partially overlapping time periods.

Referring to FIG. 12, the process 1200 may begin in operation 1201. In operation 1201, a first AP performs negotiation with a second AP for C-TDMA (or TDMA-based multi-AP coordination). Both the first AP and the second AP are participating in the C-TDMA. In this example, the first AP is a TXOP sharing AP and the second AP is a TXOP shared AP. Then, the process 1200 proceeds to operation 1203.

In operation 1203, the first AP obtains a TXOP on a wireless channel. Then, the process 1200 proceeds to operation 1205.

In operation 1205, the first AP transmits a TXOP allocation announcement frame to the second AP to announce an upcoming TXOP allocation schedule. In an embodiment, the TXOP allocation announcement frame can be an MU-RTS trigger frame. Then, the process 1200 proceeds to operation 1207.

In operation 1207, the first AP receives an acknowledgment frame from the second AP in response to the TXOP allocation announcement frame. In an embodiment, the acknowledgment frame can be a CTS frame. Then, the process 1200 proceeds to operation 1209.

In operation 1209, the first AP transmits an MU-RTS TXOP sharing (TXS) trigger frame to the second AP to allocate a portion of obtained TXOP according to the TXOP allocation announcement frame. Then, the process 1200 proceeds to operation 1211.

In operation 1211, the first AP receives a CTS frame from the second AP in response to the MU-RTS TXS trigger frame.

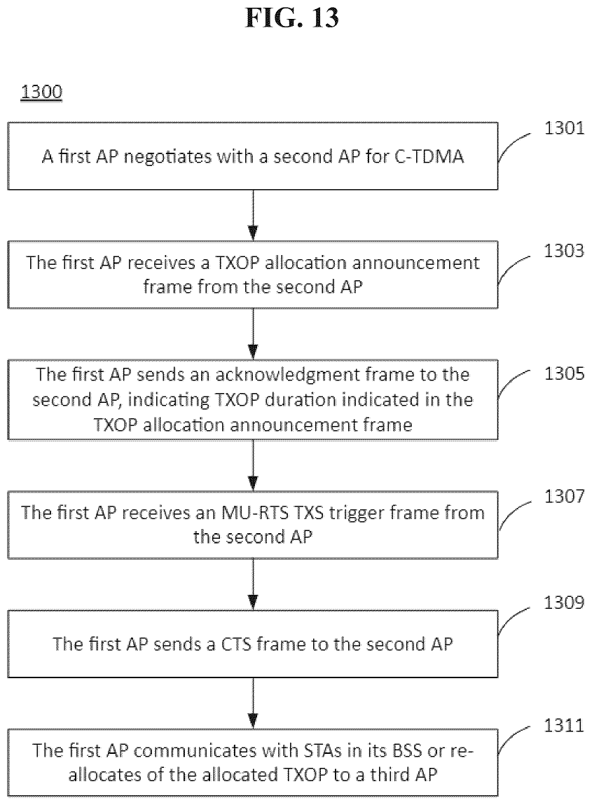

FIG. 13 shows an example process 1300 for a TXOP sharing in accordance with an embodiment. For explanatory and illustration purposes, the process 1300 may be performed by a TXOP shared AP. Although one or more operations are described or shown in a particular sequential order, in other embodiments the operations may be rearranged in a different order, which may include performance of multiple operations in at least partially overlapping time periods.

Referring to FIG. 13, the process 1300 may begin in operation 1301. In operation 1301, a first AP performs negotiation with a second AP for C-TDMA. Both the first AP and the second AP are participating in the C-TDMA. In this example, the first AP is a TXOP shared AP and the second AP is a TXOP sharing AP. Then, the process 1300 proceeds to operation 1303.

In operation 1303, the first AP receives a TXOP allocation announcement frame from the second AP that announces an upcoming TXOP allocation schedule by the second AP. The TXOP allocation announcement frame indicates duration information for the TXOP obtained by the second AP. The duration information is used for NAV setting by receiving STAs. In an embodiment, the TXOP allocation announcement frame can be an MU-RTS trigger frame. Then, the process 1300 proceeds to operation 1305.

In operation 1305, the first AP sends an acknowledgment frame to the second AP in response to the TXOP allocation announcement frame. In an embodiment, the acknowledgment frame can be a CTS frame. The acknowledgment frame includes a duration indicating the TXOP duration indicated in the TXOP allocation announcement frame. Other STAs listening to the acknowledgment frame, in the BSS of the first AP, update their NAV based on the duration. Then, the process 1300 proceeds to operation 1307.

In operation 1307, the first AP receives an MU-RTS TXS trigger frame from the second AP that allocates a portion of obtained TXOP according to the TXOP allocation announcement frame. Then, the process 1300 proceeds to operation 1309.

In operation 1309, the first AP sends a CTS frame to the second AP in response to the MU-RTS TXS trigger frame. Then, the process 1300 proceeds to operation 1311.

In operation 1311, the first AP communicate with STAs in its BSS during the allocated TXOP period. Additionally, the first AP may allocate a portion of the allocated TXP to a third AP.

The disclosure presents various embodiments of updating the NAV by TXOP sharing STAs and TXOP shared STAs in C-TDMA, enabling STAs participating in C-TDMA to avoid collisions and protect the TXOP.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to cause:
obtaining a transmission opportunity (TXOP) for a first duration on a wireless channel;
transmitting a first frame that announces an upcoming TXOP allocation schedule, the first frame including i) one or more recipient STAs for upcoming TXOP allocation and ii) duration information for setting a network allocation vector (NAV) by one or more STAs receiving the first frame, the duration information being associated with the first duration;
receiving, from one or more second STAs, one or more second frames that acknowledge the first frame, wherein each second STA is a recipient STA; and
transmitting, to the or more second STAs, a third frame allocating a portion of obtained TXOP based on the upcoming TXOP allocation schedule.

2. The first STA of claim 1, wherein each second frame includes duration information for setting a NAV by one or more receiving STAs, the duration information of each second frame is associated with the first duration.

3. The first STA of claim 1, wherein the first frame is a multi-user (MU) request-to-send (RTS) trigger frame, and each second frame is a CTS frame, the MU-RTS trigger frame soliciting simultaneous CTS frames from two or more second STAs.

4. The first STA of claim 1, wherein the third frame is a MU-RTS TXOP sharing trigger frame that indicates a time allocated to the one or more second STAs within the obtained TXOP.

5. The first STA of claim 1, wherein the first STA is either an AP STA or a non-AP STA, and each of the one or more second STAs is either an AP STA or a non-AP STA.

6. The first STA of claim 1, wherein:
the first STA is a first AP STA, and a second STA is a second AP STA; and
the first AP STA and the second AP STA participates in a time division multiple access (TDMA)-based multi-AP coordination.

7. The first STA of claim 6, wherein the processor is further configured to cause:
receiving, from the second AP STA, a second frame that acknowledges the first frame, the second frame including duration information for setting a NAV by one or more non-AP STA in a BSS in the second AP STA.

8. The first STA of claim 7, wherein the duration information is associated with the first duration.

9. A first station (STA) in a wireless network, comprising:
a memory; and
a processor coupled to the memory, the processor configured to cause:
receiving, from a second STA, a first frame that announces an upcoming transmission opportunity (TXOP) allocation schedule, the first frame including i) one or more recipient STAs for upcoming TXOP allocation and ii) duration information for setting a network allocation vector (NAV) by one or more STAs receiving the first frame, the duration information being associated with TXOP obtained by the second STA;
transmitting, to the second STA, a second frame that acknowledges the first frame based on a determination that the first STA is a recipient STA for upcoming TXOP allocation;
receiving, from the second STA, a third frame allocating a portion of the TXOP based on the upcoming TXOP allocation schedule; and
performing a communication with another STA based on the allocated portion of the TXOP.

10. The first STA of claim 9, wherein the second frame includes duration information for setting a NAV by one or more receiving STAs, the duration information is associated with the TXOP.

11. The first STA of claim 9, wherein the first frame is a multi-user (MU) request-to-send (RTS) trigger frame, and the second frame is a CTS frame.

12. The first STA of claim 9, wherein the third frame is a MU-RTS TXOP sharing trigger frame that indicates a time allocated to the first STA within the TXOP.

13. The first STA of claim 9, wherein the first STA is either an AP STA or a non-AP STA, and the second STA is either an AP STA or a non-AP STA.

14. The first STA of claim 9, wherein:
the first STA is a first AP STA, and a second STA is a second AP STA; and
the first AP STA and the second AP STA participates in a time division multiple access (TDMA)-based multi-AP coordination.

15. The first STA of claim 14, wherein the processor is configured to cause:
transmitting, to the second AP STA, a second frame that acknowledges the first frame, the second frame including duration information for setting a NAV by one or more non-AP STA in a BSS in the first AP STA, the duration information being associated with the TXOP.

16. A method performed by a first station (STA) in a wireless network, comprising:
obtaining a transmission opportunity (TXOP) for a first duration on a wireless channel;
transmitting a first frame that announces an upcoming TXOP allocation schedule, the first frame including i) one or more recipient STAs for upcoming TXOP allocation and ii) duration information for setting a network allocation vector (NAV) by one or more STAs receiving the first frame, the duration information being associated with the first duration;
receiving, from one or more second STAs, one or more second frames that acknowledge the first frame, wherein each second STA is a recipient STA; and
transmitting, to the or more second STAs, a third frame allocating a portion of obtained TXOP based on the upcoming TXOP allocation schedule.

17. The method of claim 16, wherein each second frame includes duration information for setting a NAV by one or more receiving STAs, the duration information of each second frame is associated with the first duration.

18. The method of claim 16, wherein the first frame is a multi-user (MU) request-to-send (RTS) trigger frame, and each second frame is a CTS frame, the MU-RTS trigger frame soliciting simultaneous CTS frames from two or more second STAs.

19. The method of claim 16, wherein the third frame is a MU-RTS TXOP sharing trigger frame that indicates a time allocated to the one or more second STAs within the obtained TXOP.

20. The method of claim 16, wherein:
the first STA is a first AP STA, and a second STA is a second AP STA;
the first AP STA and the second AP STA participates in a time division multiple access (TDMA)-based multi-AP coordination; and
the method further comprising:
receiving, from the second AP STA, a second frame that acknowledges the first frame, the second frame including duration information for setting a NAV by one or more non-AP STA in a BSS in the second AP STA, wherein the duration information is associated with the first duration.
